(19) United States
(12) Patent Application Publication
(10) Pub. No.: US 2012/0103714 A1
(43) Pub. Date: May 3, 2012

(54) BATTERY PACK HOUSING ASSEMBLY FOR ELECTRIC VEHICLE USING PLASTIC COMPOSITE MATERIAL

(75) Inventors: Chi Hoon Choi, Suwon (KR); Yo Han Hahm, Seoul (KR); Hyun Min Kang, Seongnam (KR)

(73) Assignees: KIA MOTORS CORPORATION, Seoul (KR); HYUNDAI MOTOR COMPANY, Seoul (KR)

(21) Appl. No.: 13/039,806

(22) Filed: Mar. 3, 2011

(30) Foreign Application Priority Data
Oct. 28, 2010 (KR) 10-2010-0106375

(51) Int. Cl. B60R 16/04

(52) U.S. Cl. 180/68.5

(57) ABSTRACT

The present invention provides a battery pack housing assembly for an electric vehicle, which is formed of a lightweight composite material to reduce the weight and configured to have a dual laminated structure with a closed cross-sectional area formed by composite molding to absorb impact energy. For this purpose, the present invention provides battery pack housing assembly for an electric vehicle using a plastic composite material, the battery pack housing assembly having an upper cover mounted at the bottom of a vehicle body, a lower housing, and a battery pack received and mounted in the lower housing, wherein the lower housing has a dual laminated structure with a closed cross-sectional area formed by bonding an upper plate and a lower plate, each composed of a fiber reinforced plastic composite material, to absorb impact energy, thus increasing structural stiffness.

### CROSS-REFERENCE TO RELATED APPLICATION

This application claims under 35 U.S.C. §119(a) the benefit of Korean Patent Application No. 10-2010-0106375 filed Oct. 28, 2010, the entire contents of which are incorporated herein by reference.

### BACKGROUND

(a) Technical Field

The present invention relates to a battery pack housing assembly for an electric vehicle using a plastic composite material. More particularly, it relates to a battery pack housing assembly for an electric vehicle, which is formed of a lightweight composite material to reduce the weight and configured to have a dual laminated structure with a closed cross-sectional area formed by composite molding to absorb impact energy.

(b) Background Art

In general, a battery pack housing assembly used in an electric vehicle typically comprises a battery pack, a battery management system, a blower, an upper cover, a lower housing, structure reinforcing members, etc., and is mounted to the bottom of a vehicle body (refer to FIG. 1).

The upper cover does not require a large load and thus can be formed using a typical plastic composite molding process. The lower housing and the structure reinforcing members are formed of steel using press molding to endure the load of a battery or formed of a plastic composite material into which a steel reinforcing member is inserted.

Typically, the steel used for the lower housing and the structure reinforcing members of the battery pack housing assembly has a thickness of about 0.7 to 2.5 mm to secure stiffness and durability, thus increasing the total weight of the battery pack housing assembly.

Meanwhile, a plurality of battery packs are arranged in a battery pack housing in view of cooling efficiency. The battery packs are mounted on a steel mounting bracket, which is welded on the lower housing, by bolting or mounting on a specially designed holder and then mounted between compartment walls, accordingly.

The battery pack housing assembly is typically mounted on a vehicle floor panel, and thus it requires chipping resistance, watertightness, and corrosion resistance. Accordingly, a separate undercover is typically mounted on the battery pack housing assembly to obtain the chipping resistance.

Examples of such mounting structures of the battery pack housing assemblies on the bottom of the vehicle floor panels include EP 1950070, EP 1939028, EP 1939027, EP 1939025, US 2009/0236162, U.S. Pat. No. 7,610,978, JP 2009-137408, etc., which use a plastic composite material into which a steel frame is inserted or a cross member formed of steel to enhance stiffness and are mounted on a vehicle cross member and a side member.

However, to the total weight of the conventional battery pack housing assemblies is exceedingly heavy, which in turn increases the total weight of the vehicle, thus reducing the fuel efficiency of the vehicle.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention relates to a battery pack housing assembly for an electric vehicle using a plastic composite material, which comprises a lower housing formed of a fiber-reinforced plastic composite material, instead of steel or instead of a hybrid structure composed of a steel frame and a plastic composite material, to reduce the weight of the vehicle, and is configured to have a dual laminated structure with a closed cross-sectional area formed of the fiber reinforced plastic composite material to absorb impact energy, not with a simple flat plate, thus improving the structural stiffness and impact properties.

Moreover, the present invention provides a battery pack housing assembly for an electric vehicle, in which peripheral components such as a structure reinforcing cross member, a structure reinforcing side member, a mounting bracket, etc are integrally formed with a lower housing a plastic material having excellent molding processability, thereby reducing the vehicle weight and production cost.

In one aspect, the present invention provides a battery pack housing assembly for an electric vehicle using a plastic composite material, the battery pack housing assembly having an upper cover mounted at the bottom of a vehicle body, a lower housing, and a battery pack received and mounted in the lower housing. Additionally, the lower housing has a dual laminated structure with a closed cross-sectional area formed by bonding an upper plate and a lower plate, each composed of a fiber reinforced plastic composite material, to absorb impact energy, thus increasing structural stiffness.

In one embodiment, the closed cross-sectional area may have an internal space surrounded by projections of the upper plate and the lower plate.

In another embodiment, the upper plate and the lower plate may be bonded together by a welding process selected from the group consisting of vibration welding, ultrasonic welding, hot plate welding, laser welding, thermal welding, and infrared welding or using an adhesive.

In still another embodiment, the closed cross-sectional area may have an impact absorbing member selectively inserted into the closed cross-sectional area to improve impact energy absorbing performance.

In yet another embodiment, the impact absorbing member may be a foam selected from the group consisting of polyurethane (PU), polystyrene (PS), polypropylene (PP), polyvinyl chloride (PVC), and polyethylene (PE).

In still yet another embodiment, the fiber-reinforced plastic composite material may be prepared by mixing raw material resin and reinforcing fibers. In this embodiment the raw material resin may be a thermoplastic resin selected from the group consisting of polypropylene (PP), polyamide (PA), polybutylene terephthalate (PBT), and polyethylene terephthalate (PET) or a thermosetting resin selected from the group consisting of unsaturated polyester (UP), epoxy, and polyurethane (PU), and the reinforcing fibers may be either glass fiber, carbon fiber, volcanic fiber, and natural fiber.

In a further embodiment, each of the upper plate and the lower plate may have at least one reinforcing rib to increase the stiffness.

In another further embodiment, the lower housing may have either a structure reinforcing cross member, a structure reinforcing side member, and/or a mounting bracket, or a combination integrally formed thereof with the lower housing.

In still another further embodiment, the upper plate may have a plurality of mounting apertures formed on the edges of the upper plate to mount the lower housing at the bottom of the vehicle body.

In yet another further embodiment, the lower housing may have a battery pack mounting portion which includes an insertion portion into which an insert bolt and an insert nut for mounting the battery pack is integrally inserted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing an exemplary mounting position of a typical battery pack housing assembly;

FIG. 2 is a schematic diagram showing the structure of a battery pack housing assembly in accordance with an exemplary embodiment of the present invention;

FIGS. 3A and 3B are perspective views of a lower housing in accordance with an exemplary embodiment of the present invention;

FIG. 4 is a plan view and a side view of a lower housing in accordance with an exemplary embodiment of the present invention;

FIG. 5 is a cross-sectional view taken along the line A-A of FIG. 4;

FIG. 6 is a cross-sectional view taken along the line B-B of FIG. 4;

FIG. 7 is a cross-sectional view taken along the line C-C of FIG. 4; and

FIGS. 8A and 8B are partial cross-sectional view of an upper plate of a lower housing in which insert bolt and nut for mounting a battery pack are integrated in accordance with a preferred embodiment of the present invention.

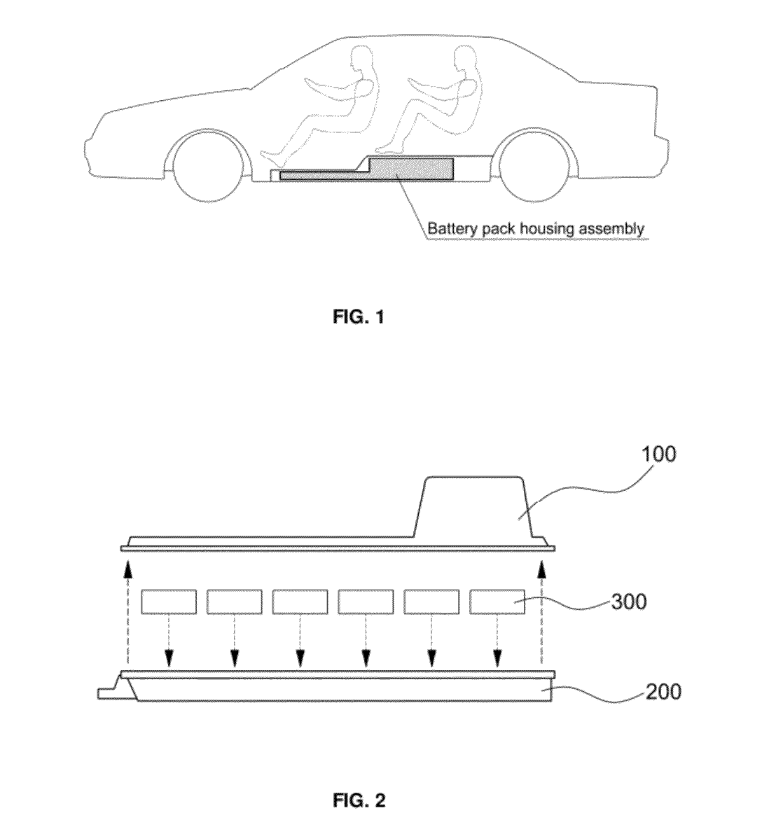

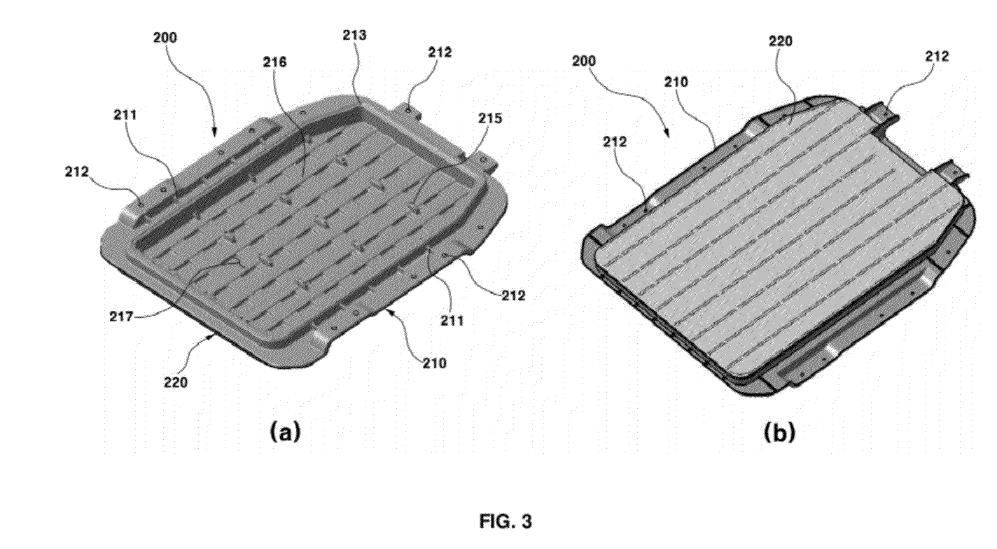

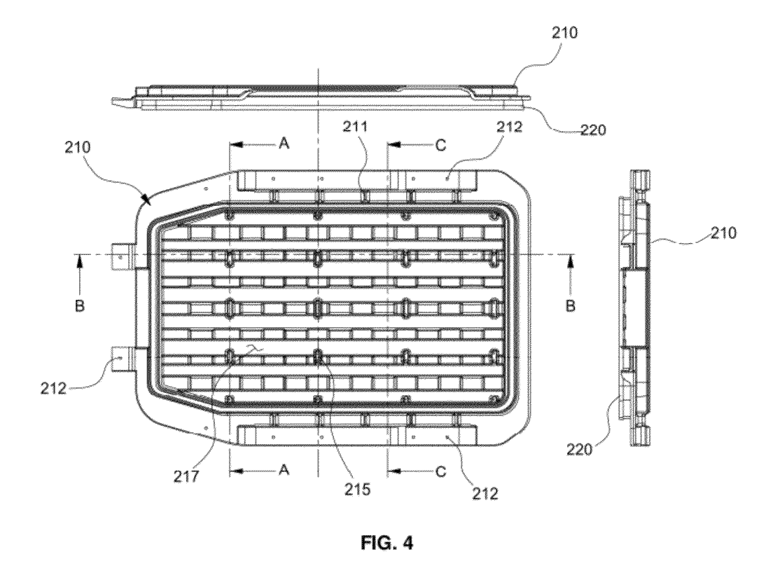

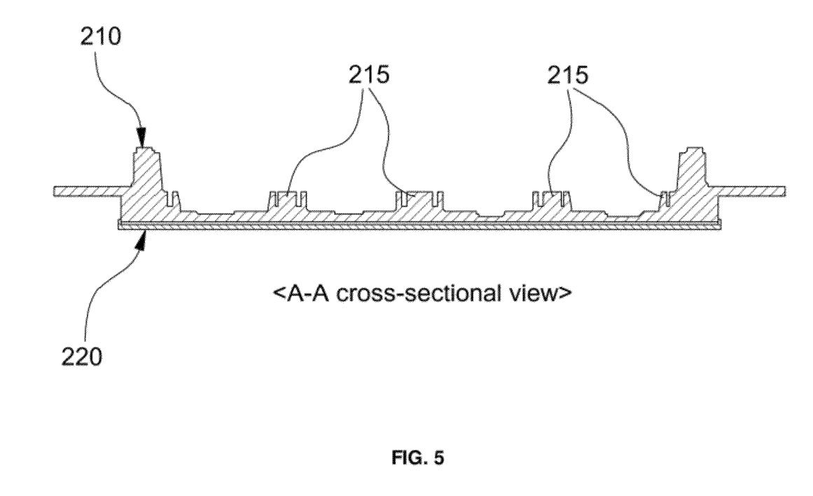

Reference numerals set forth in the Drawings includes reference to the following elements as further discussed below:

| | |
|---|---|
| S: closed cross-sectional area | 100: upper cover |
| 200: lower housing | 210: upper plate |
| 211: reinforcing rib | 212: mounting hole |
| 213 & 216: projections | 214: insertion projection |
| 215: insertion portion | 217: battery pack mounting portion |
| 218: impact absorbing member | 300: battery pack |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a battery pack housing assembly for an electric vehicle, which is formed of a fiber-reinforced plastic composite material to reduce the weight of a vehicle and configured to have a dual laminated structure (or dual structure) with a closed cross-sectional area to absorb impact energy, thus increasing the structural stiffness and impact properties.

Referring to FIG. 2, a typical battery pack housing assembly comprises an upper cover 100 mounted at the bottom of a vehicle body, a lower housing 200, and a battery pack 300 received and mounted in the lower housing 200.

In the present invention, the lower housing 200 of the battery pack housing assembly is formed of a fiber-reinforced plastic composite material by a molding process such as injection molding or compression molding.

The fiber-reinforced plastic composite material for an upper plate 210 and a lower plate 220 of the lower housing 200 may be prepared by mixing raw material resin and reinforcing fibers. The raw material resin may be for example a thermoplastic resin selected from the group consisting of polypropylene (PP), polyamide (PA), polybutylene terephthalate (PBT), and polyethylene terephthalate (PET) or a thermosetting resin selected from the group consisting of unsaturated polyester (UP), epoxy, and polyurethane (PU). The reinforcing fibers may be, for example, glass fiber, carbon fiber, volcanic fiber, and/or natural fiber or a combination thereof.

The lower housing 200 is composed of the fiber-reinforced plastic composite material having a dual laminated structure with a closed cross-sectional area S from by bonding the upper plate 210 and the lower plate 220 to absorb impact energy, thus increasing the stiffness of the lower housing 200.

That is, when the lower housing 200 having the dual laminated structure with the closed cross-sectional area S is formed by bonding the upper plate 210 and the lower plate 220 composed of the fiber-reinforced plastic composite material, the impact energy absorbing performance against external impact is improved.

In some embodiments of the present invention, the closed cross-sectional area S may be formed on the four edges and the bottom of the lower housing 200. More specifically, the closed cross-sectional area S is formed on the four edges of a battery pack mounting portion 217 for accommodating the battery pack 300 and on the bottom surface of the battery pack mounting portion 217.

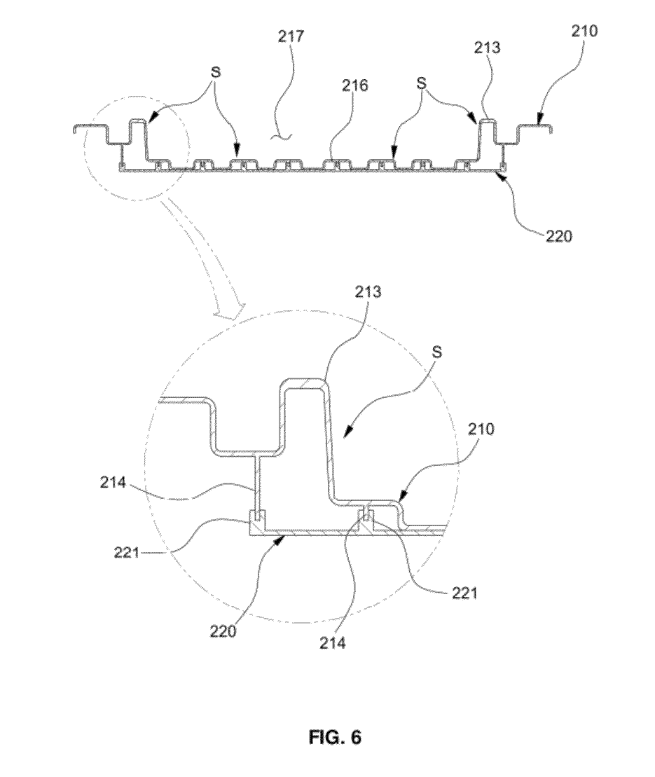

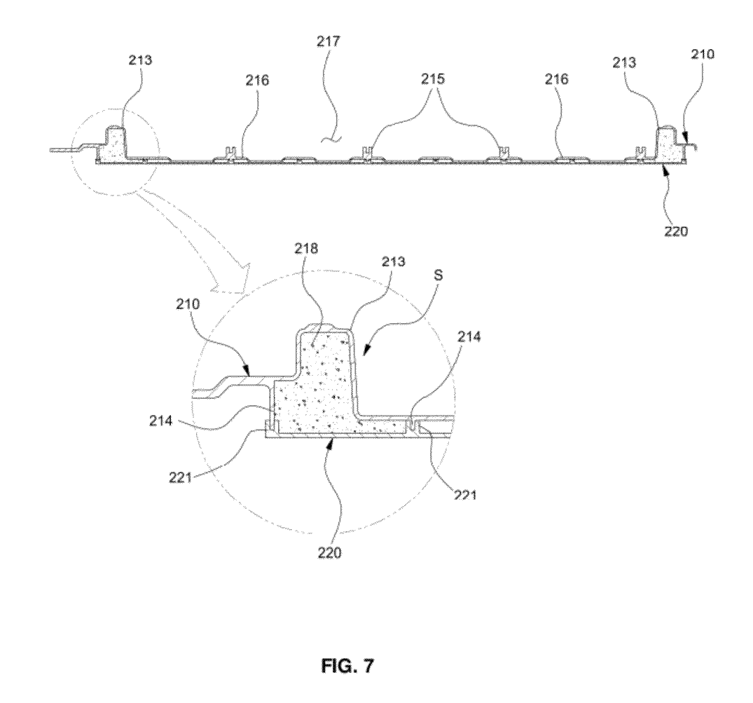

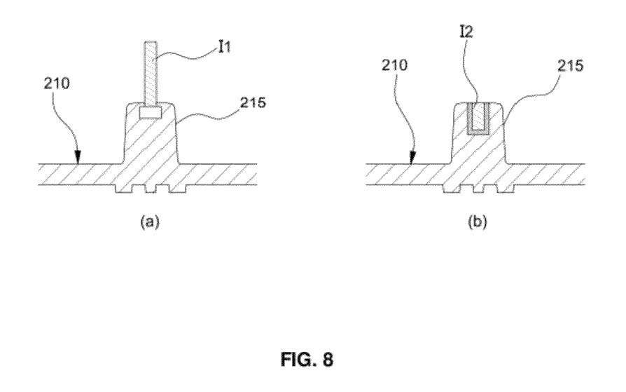

To form the closed cross-sectional area S, as shown in FIGS. 6 and 7, a projection 213 projecting from the bottom surface is formed along the edges of the battery pack mounting portion 217 on the upper plate 210 of the lower housing 200 and a grid projection 216 projecting from the bottom surface of the battery pack mounting portion 217 is formed on the upper plate 210 of the lower housing 200. An insertion projection 214 inserted into each insertion port 221 is formed on the bottom of the projections 213 and 216.

The insertion port 221 with a groove, into which each insertion projection 214 is inserted, is formed on the lower plate 220 of the lower housing 200. Therefore, when the insertion projections 214 are inserted into the insertion ports 221, and when the upper plate 210 and the lower plate 220 are fixedly bonded to each other by a welding process, which will be described later, the closed cross-sectional area S having an internal space surrounded by the projections 213 and 216 and the lower plate 220 is formed.

That is, the closed cross-sectional area S is formed into a structure having the internal space surrounded by the projections 213 and 216 of the upper plate 210 and the lower plate 220.

Moreover, an impact absorbing member 218 may be either partially or fully inserted into the closed cross-sectional area S to improve the impact energy absorbing performance of the lower housing 200, if necessary.

Additionally, in some embodiments of the present invention, the impact absorbing member 218 may be a foam selected from the group consisting of polyurethane (PU), polystyrene (PS), polypropylene (PP), polyvinyl chloride (PVC), and polyethylene (PE), which can absorb impact energy during collision.

Moreover, at least one reinforcing rib 211 may be either partially or entirely formed on the upper plate 210 and the lower plate 220 to increase the stiffness. The reinforcing rib 211 may have various shapes such as a bent shape, a grid shape, a net shape, a cross shape, a hexagonal honeycomb shape, etc., or may have a structure in which a rib diagonally crossing the inside of a grid reinforcing member is provided or a combination thereof.

Peripheral components such as a structure reinforcing cross member, a structure reinforcing side member, a battery mounting bracket, etc. may be provided around the lower housing 200. The upper plate 210 and the lower plate 220 of the lower housing 200 may be formed by a composite molding process thereby utilizing the benefits of molding processability of the plastic composite material and, at the same time, at least one of these peripheral components may be integrally formed with the lower housing 200.

In embodiments where the peripheral components are integrally formed with the lower housing 200, it is possible to eliminate the need for fastening the peripheral components and the lower housing 200, and thus it is possible to even further reduce the weight and production cost.

Moreover, a plurality of mounting apertures 212 are formed at regular intervals on the edges of the upper plate 210 of the lower housing 200 to mount the lower housing 200 at the bottom of the vehicle body.

Furthermore, an insert bolt 11 and an insert nut 12 for mounting the battery pack 300 are integrally formed on the battery pack mounting portion 217 of the lower housing 200.

That is, the insert bolt 11 and the insert nut 12 integrally inserted into an insertion portion 215 projecting from the battery pack mounting portion 217 at a predetermined position, and thus it is possible to eliminate the battery mounting brackets, thereby further reducing the weight and production cost.

Since the present invention uses a fiber-reinforced plastic composite material based on a thermoplastic resin, it is possible to form the dual laminated structure by bonding the upper plate 210 and the lower plate 220 by a welding process without using an adhesive.

According to test results, the interfacial strength of thermally welded surfaces is higher than that of surfaces bonded together with an adhesive, and the welding process can minimize the reduction in strength of the welded surfaces due to thermal contraction and expansion.

The welding process for bonding the upper plate 210 and the lower plate 220 of the lower housing 200 may include vibration welding, ultrasonic welding, infrared welding, hot plate welding, laser welding, or thermal welding or a combination thereof. Moreover, the upper plate 210 and the lower plate 220 of the lower housing 200 may be bonded together with an adhesive.

In the case of the injection molding or compression molding used in the present invention, a three-dimensional rib pattern can be freely implemented by mold design, and thus it is possible to form at least one reinforcing rib 211 having the desired thickness, height, and profile at a predetermined position of the lower housing 200. The structure of the reinforcing rib 211 can increase the structural stiffness and impact properties of the lower housing 200.

According to the lower housing 200 of the battery pack housing assembly of the present invention, it is possible to reduce the weight by about 30 percent compared to the conventional steel plate used in the conventional devices. Additionally, as the peripheral components are integrally formed with the lower housing 200, it is possible to improve the productivity and reduce the production cost.

Moreover, with the use of a plastic composite material, it is possible to fundamentally solve the corrosion problem. Furthermore, since the lower housing 200 has the dual laminated structure with the closed cross-sectional area S capable of absorbing impact energy, it is possible to obtain the chipping resistance and watertightness even when the lower plate 220 of the lower 200 is partially damaged by external impact, and thus it is not necessary to mount a separate undercover to protect the lower housing 200.

Advantageously, the above-described battery pack housing assembly of the present invention can be applied to all vehicles that use a battery such as a hybrid vehicle as well as the electric vehicle.

As described above, according to the present invention, it is possible to reduce the weight of the battery pack housing assembly compared to the conventional battery pack housing assemblies. Additionally, it is also possible to improve the structural stiffness and impact properties, improve the productivity and reduce the weight and production costs by integrating the peripheral components with the lower housing.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A battery pack housing assembly for an electric vehicle using a plastic composite material comprising an upper cover mounted at the bottom of a vehicle body, a lower housing, and a battery pack received and mounted in the lower housing,
wherein the lower housing has a dual laminated structure with a closed cross-sectional area formed by bonding an upper plate and a lower plate, each composed of a fiber reinforced plastic composite material, to absorb impact energy, thus increasing structural stiffness.

2. The battery pack housing assembly of claim 1, wherein the closed cross-sectional area has an internal space surrounded by projections of the upper plate and the lower plate.

3. The battery pack housing assembly of claim 1, wherein the upper plate and the lower plate are bonded together by a welding process selected from the group consisting of vibration welding, ultrasonic welding, hot plate welding, laser welding, thermal welding, and infrared welding or using an adhesive.

4. The battery pack housing assembly of claim 1, wherein the closed cross-sectional area comprises an impact absorbing member selectively inserted into the closed cross-sectional area to improve impact energy absorbing performance.

5. The battery pack housing assembly of claim 4, wherein the impact absorbing member comprises a foam selected from the group consisting of polyurethane (PU), polystyrene (PS), polypropylene (PP), polyvinyl chloride (PVC), and polyethylene (PE).

6. The battery pack housing assembly of claim 1, wherein the fiber-reinforced plastic composite material is prepared by mixing raw material resin and reinforcing fibers, the raw material resin comprising a thermoplastic resin selected from the group consisting of polypropylene (PP), polyamide (PA), polybutylene terephthalate (PBT), and polyethylene terephthalate (PET) or a thermosetting resin selected from the group consisting of unsaturated polyester (UP), epoxy, and polyurethane (PU), and the reinforcing fibers comprising at least one selected from the group consisting of glass fiber, carbon fiber, volcanic fiber, and natural fiber.

7. The battery pack housing assembly of claim 1, wherein each of the upper plate and the lower plate comprises at least one reinforcing rib to increase the stiffness.

8. The battery pack housing assembly of claim 1, wherein the lower housing comprises at least one selected from the group consisting of structure reinforcing cross member, structure reinforcing side member, and mounting bracket, and a combination integrally formed thereof with the lower housing.

9. The battery pack housing assembly of claim 1, wherein the upper plate comprises a plurality of mounting apertures formed on the edges of the upper plate to mount the lower housing at the bottom of the vehicle body.

10. The battery pack housing assembly of claim 1, wherein the lower housing comprises a battery pack mounting portion including an insertion portion into which an insert bolt and an insert nut for mounting the battery pack is integrally inserted.
